(19) United States
(12) Patent Application Publication
(10) Pub. No.: US 2008/0300012 A1
(43) Pub. Date: Dec. 4, 2008

(54) MOBILE PHONE AND METHOD FOR EXECUTING FUNCTIONS THEREOF

(76) Inventor: Mun Hak AN, SEOUL (KR)

Correspondence Address: IPLA P.A., 3580 WILSHIRE BLVD., 17TH FLOOR, LOS ANGELES, CA, 90010, US

(21) Appl. No.: 12/132,567

(22) Filed: Jun. 3, 2008

(30) Foreign Application Priority Data
Jun. 4, 2007 (KR) 10-2007-0054278
Jun. 11, 2007 (KR) 10-2007-0056920
Dec. 17, 2007 (KR) 10-2007-0131917

(51) Int. Cl. H04M 1/00; G10L 13/08

(52) U.S. Cl. 455/556.1; 704/260; 704/E13.001

(57) ABSTRACT

Provided is a mobile phone which converts an input first word to a second word, displays the second word, extracts voice data corresponding to the second word and outputs the extracted voice data and a method of converting a word and outputting the converted word as a voice in the mobile phone. Furthermore, there is also provided a mobile phone which receives and stores a composite video signal including an audio signal and a video signal, inputs a playback point of the stored composite video signal and a playback speed exceeding 1X and plays the sound and image corresponding to the stored composite video signal from the input playback point at the input playback speed and a composite image processing method of the mobile phone.

### CROSS REFERENCES

This application claims foreign priority under Paris Convention and 35 U.S.C. §119 to Korean Patent Application No. 10-2007-0054278 filed 4 Jun. 2007, to Korean Patent Application No. 10-2007-0056920 filed 11 Jun. 2007, and to Korean Patent Application No. 10-2007-0131917 filed 17 Dec. 2007, each with the Korean Intellectual Property Office.

### BACKGROUND OF THE INVENTION

1. Field of the Invention

The present invention relates to a mobile phone and a method for executing functions thereof and, more particularly, to a mobile phone for converting an input word to another word, outputting the converted word as a voice and playing a composite image from a point selected by a user at a playback speed selected by the user and a method for executing functions thereof.

2. Background of the Related Art

A mobile phone market is rapidly growing within a short period due to new technology and functions which incite consumers to buy mobile phones. With the development of mobile phone technology, various applications which exceed simple applications and meet demands of users are installed in mobile phones. Accordingly, the users can use voice information, text information, image information, MP3 (MPEG (Moving Picture Experts Group) layer 3), games and so on through mobile phones.

When users input words using computers or devices such as electronic dictionaries, they usually input the words in their native languages. Particularly, in the case of Chinese characters, a user should type a word in his native language and convert the typed word to corresponding Chinese characters. In the case of Japanese, a user should type the alphabet corresponding to the pronunciation of a Japanese word and convert the alphabet to the Japanese word. Furthermore, Chinese characters cannot be input through keypads of mobile phones, in general.

Mobile phone users frequently use a short message service. The users combine characters, numerals and symbols to create emotion icons and represent their emotions and thoughts using the emotion icons. However, many key inputs are needed to input an emotion icon, and thus it is inconvenient for the users to use the emotion icons.

In order to make a voice call, transmit/receive short messages, listen to music, watch moving pictures and learn languages, users must carry devices such as mobile phones, MP3 players, PMPs and electronic dictionaries.

Meantime, the number of people who use audio and video lectures in order to learn languages, obtain certificates of qualification and prepare for getting a job is increasing. The audio and video lectures have many advantages that people are not required to go to schools and educational institutes to attend a lecture and the time and efforts of students are saved.

The audio and video lectures are played at a speed of 1.5× and 2× in order to save a listening time and improve concentration in many cases. To listen to voices is called speed listening. This speed listening is a method widely used to develop brains. When a large amount of information is input at a high speed through speed listening, Wernicke nucleus called language nucleus becomes more sensitive. Information processed in the Wernicke nucleus is sent to parts of a brain and a chain reaction of activation occurs. Accordingly, the function of nerve cells of the brain is effectively promoted, and thus the cerebrum extends its brain power.

However, current mobile phones do not provide a function by which a user sets a playback point of a desired voice or a desired image while storing received voices and images in real time or controls a playback speed, and thus there are limitations in learning using the mobile phones.

### SUMMARY OF THE INVENTION

Accordingly, the present invention has been made in view of the above-mentioned problems occurring in the prior art, and it is a primary object of the present invention to provide a mobile phone which converts a word input by a user in the native language of the user to a word in a foreign language or special characters and a method of converting a word and outputting the converted word as a voice in the mobile phone.

Another object of the present invention is to provide a mobile phone which converts an input native language into a foreign language that is difficult to input, provides voice data corresponding to the converted foreign language and controls the output speed of the voice data and a method of converting a word and outputting the converted word as a voice in the mobile phone.

Yet another object of the present invention is to provide a mobile phone which plays the voice and image of a received or stored composite image at a position selected by a user at a playback speed selected by the user and a composite image processing method thereof.

To accomplish the above objects of the present invention, according to the present invention, there is provided a method of converting a word and outputting a voice corresponding to the converted word in a mobile phone, comprising the steps of inputting a first word, displaying at least one conversion type corresponding to the first word on a screen, converting the first word to a second word of a conversion type selected from the displayed conversion type, displaying the converted second word on the screen and outputting voice data corresponding to the second word when a voice output request for the displayed second word is input.

According to the present invention, there is also provided a mobile phone having functions of converting a word and outputting a voice. The mobile phone includes an input unit, a word converter, an image output unit and a voice converter. A first word is input through the input unit. The word converter provides at least one conversion type corresponding to the input first word and converts the first word to a second word of a conversion type selected from the provided conversion type. The image output unit displays the input first word, the provided conversion type and the converted second word on a screen. The voice converter converts the second word to voice data corresponding thereto and outputs the voice data when a voice output request for the second word is input through the input unit.

According to the present invention, there is also provided a method of processing a sound and an image in a mobile phone, comprising the steps of receiving a composite video signal including an audio signal and a video signal and storing the received composite video signal, inputting a playback point of the stored composite video signal and a playback speed exceeding 1× and playing a sound and an image corresponding to the stored composite video signal from the input playback point at the input playback speed.

According to the present invention, there is also provided a mobile phone having a function of processing sounds and images. The mobile phone includes a receiving unit, a storage unit, an input unit and a controller. The receiving unit receives a composite video signal including an audio signal and a video signal. The storage unit stores the received composite video signal. A playback point of the stored composite video signal and a playback speed exceeding 1× are input through the input unit. The controller plays a sound and an image corresponding to the stored composite video signal from the input playback point at the input playback speed.

According to the first embodiment of the present invention, an input first word can be converted to a second word even though corresponding keys are not repeatedly pushed when a foreign language, a frequently used word and emotion icons are input, and thus inconvenience according to key input can be decreased and the number of times of typing can be reduced.

Furthermore, the second word corresponding to the first word is stored in a plurality of foreign languages in a plurality of conversion tables, and thus the first word can be easily converted to a word in a desired foreign language by inputting the first word in a familiar native language without converting an input mode into a corresponding foreign language mode.

Moreover, a user can listen to voice data corresponding to a converted foreign language and control the output speed of the voice data so that the mobile phone is useful for the user to have a conversation with a foreigner or learn a foreign language. Particularly, the mobile can be useful for learning to listen to a foreign language because the output speed of the foreign language can be controlled.

In addition, a screen is partitioned and the input first word and at least one converted second word are respectively displayed on the partitioned parts of the screens. This provides an interface convenient for users.

According to the second embodiment of the present invention, a received or stored composite image can be played according to a playback instruction of a user so as to hear a voice and watch an image at a desired speed. Furthermore, when the composite image is received in real time, the composite image can be stored while being received and, simultaneously, the stored composite image can be played at a desired playback point and a desired playback speed.

Accordingly, when a user hears a lecture in order to learn a language, obtain a certificate of qualification or prepare for getting a job, the user can rapidly play voices and images and freely move to a desired position to obtain the same effect as speed listening, save a time required to hear the lecture and improve comprehension through repeated listening.

Moreover, the user can rapidly hear and watch voices and images to rapidly grasp the overall content, improve concentration and enhance achievement. In addition, the user can easily hear the lecture while moving because the lecture is played using a mobile phone.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram representing principal components of a mobile phone according to a first embodiment of the present invention;

FIG. 2 illustrates the structure of a text DB according to the first embodiment of the present invention;

FIG. 3 is a flow chart of a setting process for converting a word and outputting the converted word as a voice according to the first embodiment of the present invention;

FIG. 4 is a flow chart of a process of converting a word and outputting the converted word as a voice according to the first embodiment of the present invention;

FIGS. 5, 6, 7 and 8 illustrate first, second, third and fourth images which represent word conversion and voice output according to the first embodiment of the present invention;

FIG. 9 is a block diagram of a mobile phone having a composite image processing function according to a second embodiment of the present invention;

FIG. 10 is a flow chart of a composite image processing method of the mobile phone according to the second embodiment of the present invention; and

FIG. 11 illustrates images which represent a process of playing a currently received digital broadcast while storing the digital broadcast according to the composite image processing method of the mobile phone according to the second embodiment of the present invention.

### DETAILED DESCRIPTION OF THE PREFERRED EMBODIMENTS

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

Conversion types used in embodiments of the present invention mean conversion of a word input by a user to a corresponding foreign language word and conversion of a word to special characters including emotion icons.

### First Embodiment—Mobile Phone

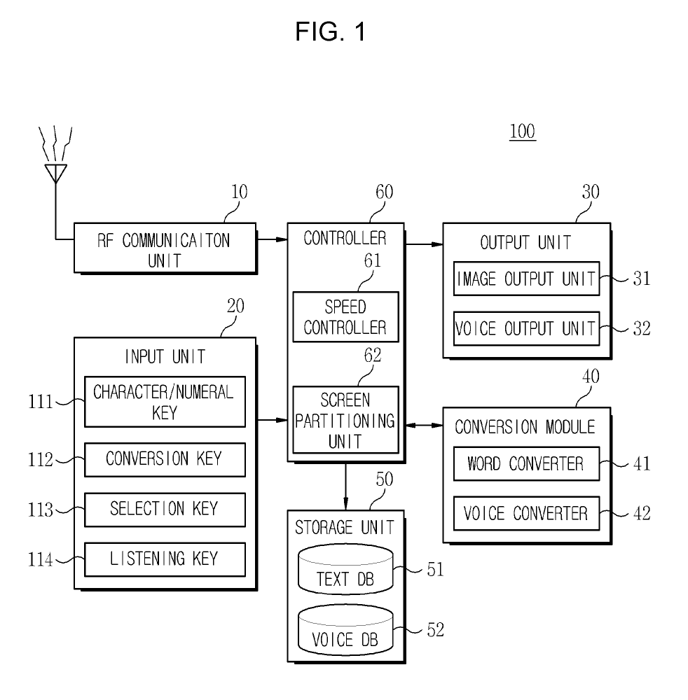

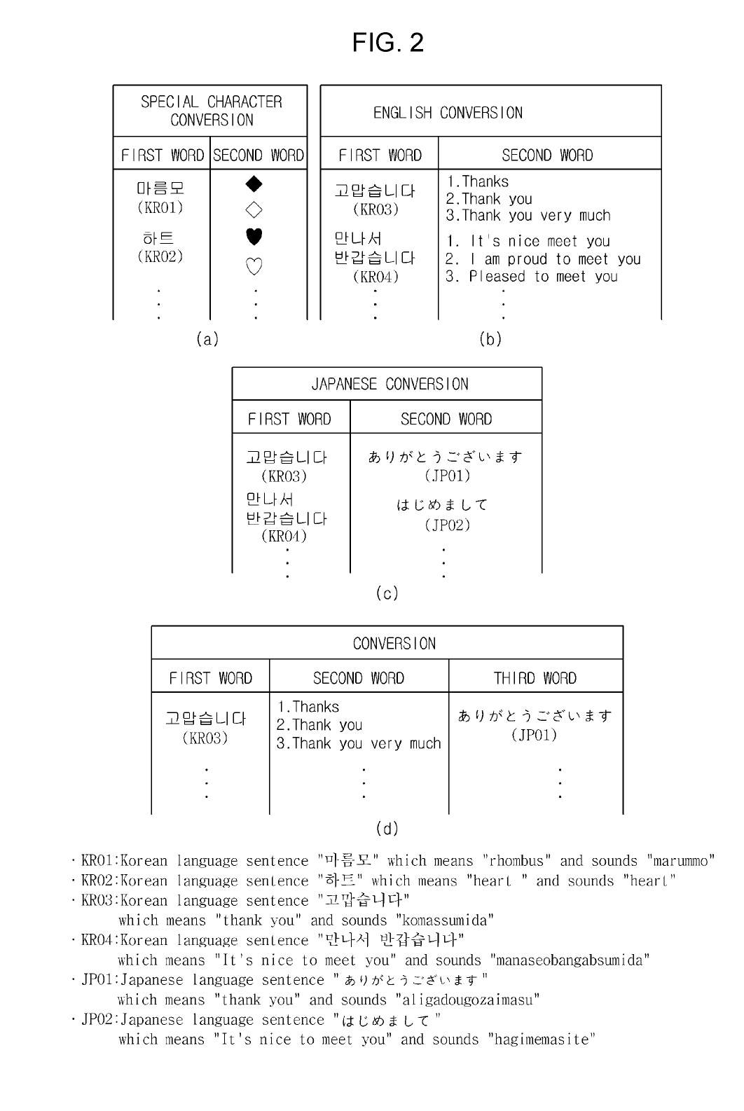

Referring to FIGS. 1 and 2, a mobile phone 100 according to a first embodiment of the present invention includes an RF communication unit 10, an input unit 20, an output unit 30, a conversion module 40, a storage unit 50 and a controller 60. The conversion module 40 includes a word converter 41 and a voice converter 42. The output unit 30 includes an image output unit 31 and a voice output unit 32. The storage unit 50 includes a text DB 51 and a voice DB 52. The controller 60 includes a speed controller 61 and a screen partitioning unit 62.

The RF communication unit 10 performs conventional RF communication between the mobile phone 100 and a mobile communication network. For example, the RF communication unit 10 makes a voice call and transmits/receives a text message through the mobile communication network.

The input unit 20 provides a signal corresponding to a key, which is input by a user in order to control the operation of the mobile phone 100, to the controller 60. The input unit 20 can include conventional keypads. The input unit 20 can be configured in the form of a touch screen, a touch pad or a scroll wheel. The input unit 20 includes character/numeral keys 111, a conversion key 112, a selection key 113 and a listening key 114. The conversion key 112, the selection key 113 and the listening key 114 may be additional keys added to the mobile phone 100 or the existing function keys or character/numeral keys 111 to which corresponding functions are mapped. The selection key 113 and the listening key 114 can select ‘conversion’ and ‘listening’ displayed on the image output unit 31 using a soft key.

The character/numeral keys 111 are general keys of the mobile phone 100. The user can input a first word to be converted to a second word using the character/numeral keys 111.

The conversion key 112 is added for a word conversion function. When the user pushes the conversion key 112, a plurality of conversion types with respect to the input first word are displayed on the image output unit 31 under the control of the controller 60. When the user moves a cursor to a word included in a text message, a memo note or a text file and pushes the conversion key 112, the controller 60 recognizes the previously input word as the first word.

The selection key 113 is used to select a conversion type of the second word that will be converted from the first word from the plurality of conversion types provided to the image output unit 31. The selection key 113 selects one of a plurality of second words mapped to the first word from a conversion table corresponding to a selected conversion type, which is selected from conversion tables stored in the text DB 51.

The listening key 114 provides a signal which requests a voice corresponding to the second word displayed on the image output unit 31 to be output to the controller 60 in order to listen to the second word as voice data.

The output unit 30 includes the image output unit 31 and the voice output unit 32 and provides a function of outputting the input first word, the converted second word and the converted voice data to the user under the control of the controller 60.

The image output unit 31 can use a liquid crystal display (LCD) or organic light emitting diodes (OLED). The image output unit 31 displays the first word input through the input unit 20 and the plurality of conversion types with respect to the input first word. The image output unit 31 displays the second word extracted from a conversion table stored in the text DB 51 by the word converter 41 and mapped to the first word.

The voice output unit 32 includes a speaker for outputting voice data corresponding to the second word. The voice output unit 32 outputs the voice data corresponding to the second word displayed on the image output unit 31 under the control of the controller 60.

The conversion module 40 includes the word converter 41 and the voice converter 42, converts the first word input through the input unit 20 to the second word and converts the second word to the voice data.

The word converter 41 extracts the second word mapped to the first word input through the input unit 20 from the text DB 51 under the control of the controller 60 and provides the second word to the controller 60. Here, when the text DB 51 includes a plurality of conversion types with respect to the first word, the word converter 41 selects a single conversion type input through the input unit 20. In addition, when there are multiple second words mapped to the first word in the conversion table corresponding to the selected conversion type, the word converter 41 extracts the multiple second words mapped to the first word input through the input unit 20 and displays the extracted multiple second words on a screen. When one of the multiple second words is selected, the word converter 41 converts the first word to the selected second word and displays the second word on the screen.

The voice converter 42 extracts voice data mapped to the second word converted by the word converter 41 from the voice DB 52 under the control of the controller 60 and provides the extracted voice data to the controller 60.

The storage unit 50 stores a program required to control the operation of the mobile phone 100 and data generated when the program is executed and includes at least one volatile memory and at least one nonvolatile memory. The storage unit 50 includes the text DB 51 and the voice DB 52 which respectively a plurality of conversion tables corresponding to the plurality of conversion types with respect to the first word input through the input unit 20 and the voice data mapped to the second word in order to convert the first word under the control of the controller 60. In addition, the storage unit 50 stores text messages, memo notes, text files and so on.

The text DB 51 stores the plurality of conversion tables corresponding to the plurality of conversion types with respect to the first word input through the character/numeral keys 111. For example, the conversion tables can be constructed as illustrated in FIGS. 2(a), 2(b), 2(c) and 2(d). FIG. 2(a) represents a special character conversion table which stores ⋄, ♦, [symbol] and ♡ as second words mapped to first words ‘diamond’ and ‘heart’.

FIG. 2(b) represents an English conversion table which stores [symbol] (Korean language sentence [symbol] which means “thank you” and sounds “komassumida”)’ as a first word and ‘Thanks’, ‘Thank you’ and ‘Thank you very much’ as a plurality of second words mapped to the first word. In addition, the English conversion table stores [symbol] [symbol] (Korean language sentence [symbol] [symbol] which means “It's nice to meet you” and sounds “manaseobangabsumida”)’ as a first word and ‘It's nice to meet you’, ‘I am proud to meet you’ and ‘Pleased to meet you’ as a plurality of second words mapped to the first word.

FIG. 2(c) represents a Japanese conversion table which stores [symbol] [symbol] (Japanese language sentence [symbol] [symbol] which means “thank you” and sounds “aligadougozaimasu”)’ as a second word mapped to a first word [symbol] and [symbol] (Japanese language sentence [symbol] which means “It's nice to meet you” and sounds “hagimemasite”)’ as a second word mapped to a first word [symbol] [symbol] .

FIG. 2(d) represents an English/Japanese conversion table which stores [symbol] as a first word, ‘Thanks’, ‘Thank you’ and ‘Thank you very much’ as a plurality of second words mapped to the first word and [symbol] [symbol] as a third word mapped to the first word.

The conversion tables can include various conversion tables for foreign languages in addition to English and Japanese and special characters such as emotion icons.

The voice DB 52 includes a voice data conversion table for the second word in the conversion table stored in the text DB 51.

The controller 60 is a microprocessor which controls the overall operation of the mobile phone 100. The controller 60 includes the speed controller 61 for controlling then output speed of the voice data corresponding to the second word and the screen portioning unit 62 for controlling partition of the screen of the image output unit 31.

The speed controller 61 stores the output speed of the voice data, input through the input unit 20 in the storage unit 50. The speed controller 61 controls the voice output unit 32 to output the voice data corresponding to the second word, provided by the voice converter 42, at the output speed input through the input unit 10 or stored in the storage unit 50.

The screen portioning unit 62 stores the number of partitions of the screen, input through the input unit 20, in the storage unit 50. The screen portioning unit 62 partitions the screen into as many parts as the stored number and controls the first word and the second word to be separately displayed.

### Method of Converting a Word and Outputting the Converted Word as a Voice

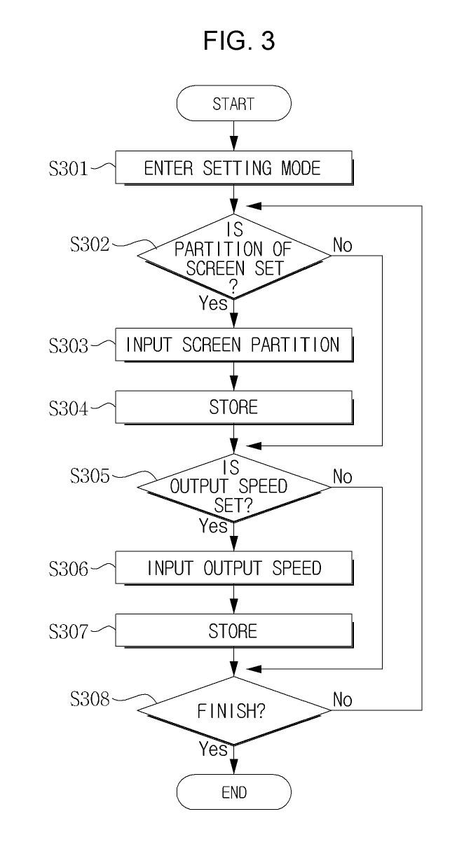

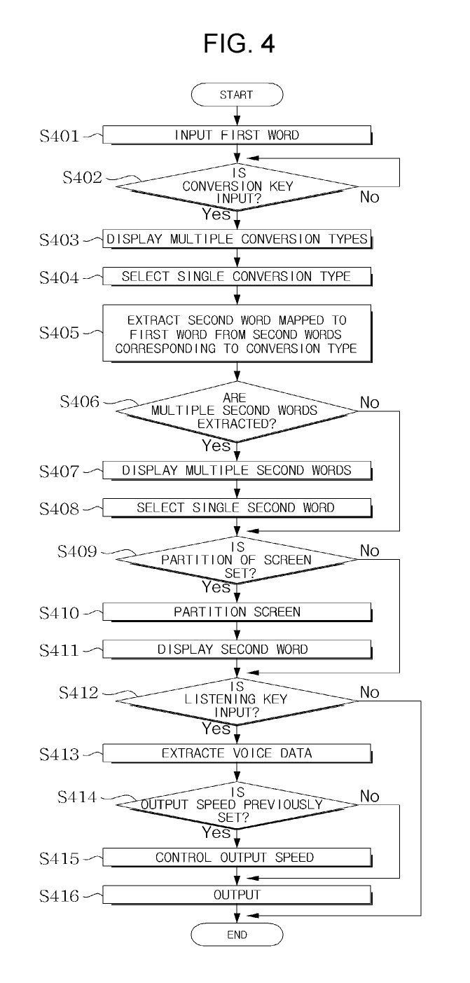

A method of converting a word and outputting the converted word as a voice in the mobile phone according to the first embodiment of the present invention includes a setting process and a process of converting a word and outputting the converted word, as illustrated in FIGS. 1, 2, 3 and 4. FIG. 3 is a flow chart of the setting process and FIG. 4 is a flow chart of the process of converting a word and outputting the converted word.

The setting process is explained with reference to FIGS. 1, 2 and 3.

The controller 60 enters a setting mode for setting options required to convert a word and output the converted word as a voice based on a signal provided by the input unit 20 in operation S301. The controller 60 detects whether partition of the screen of the image output unit 31 is set in operation S302.

When the controller 60 receives a signal for selecting the partition of the screen of the image output unit 31 from the input unit 20 in operation S302, the controller 60 performs operation S303. When the controller 60 receives a signal which does not select the partition of the screen of the image output unit 31 from the input unit 20 in operation S302, the controller 60 carries out operation S305.

The controller 60 receives the number of partitions of the screen of the image output unit 31 from the input unit 20 in operation S303. Then, the screen portioning unit 62 stores the received number of partitions in the storage unit 50 in operation S304.

The controller 60 determines whether a signal for setting the output speed of voice data is received from the input unit 20 in operation S305. The speed controller 61 performs operation S306 when the signal is received in operation S305. The controller 60 carries out operation S308 when the signal is not received in operation S305.

When the speed controller 61 receives the output speed of voice data corresponding to a second word from the input unit 20 in operation S306, the speed controller 61 stores the received output speed of the voice data in the storage unit 50 in operation S307. For example, when the output speed is set to 2×, the speed controller 61 controls the voice output unit 32 to output the voice data at a speed twice a predetermined standard speed. When the output speed is not set in the operation S305, however, the speed controller 61 controls the voice output unit 32 to output the voice data at the predetermined standard speed.

The controller 60 finishes the setting mode when receiving a completion signal for finishing the setting mode from the input unit 20 in operation S308. The controller 60 returns to operation S302 to repeat the setting process when the controller 60 does not receive the completion signal in operation S308.

The process of converting a word and outputting the converted word as a voice is explained with reference to FIGS. 1, 2, 3 and 4.

The controller 60 detects input of a first word from the input unit 20 in operation S401, and then the controller 60 determines whether the conversion key 112 for converting the first word to a second word is input from the input unit 20 in operation S402. The controller 60 performs operation S403 when the conversion key 112 is input from the input unit 20 and returns to operation S402 to wait for input of the conversion key 112 when the conversion key is not input in operation S302.

The controller 403 displays a plurality of conversion types for converting the first word to the second word on the screen of the image output unit 31. Specifically, when the first word can be converted to the second word in English and Japanese, the controller 60 displays the conversion types by which English or Japanese can be selected on the image output unit 31.

When the controller 60 receives a selection signal for selecting one of the conversion types displayed on the image output unit 31 from the input unit 20 in operation S404, the word converter 41 extracts the second word mapped to the first word and provides the second word to the controller 60 in operation S405. That is, the word converter 41 selects a conversion table corresponding to the conversion type selected in operation S404 from the conversion tables stored in the text DB 51 of the storage unit 50 in operation S405. Then, the word converter 41 extracts the second word mapped to the first word input in operation S401 from second words which construct the selected conversion table. More specifically, when the conversion type selected in operation S404 corresponds to English, the word converter 41 extracts the second word mapped to the first word from a conversion table constituted of second words in English. When the conversion type selected in operation S404 corresponds to Japanese, the word converter 41 extracts the second word mapped to the first word from a conversion table constituted of second words in Japanese.

In operation S406, the controller 60 determines whether a plurality of second words are extracted in operation S405. The controller 60 performs operation S407 when the plurality of second words are extracted and carries out operation S409 when a single second word is extracted.

The controller 60 displays the extracted plurality of second words on the image output unit 31 in operation S407 and receives a signal for selecting one of the plurality of second words from the selection key in operation S408.

Subsequently, the controller 60 determines whether the partition of the screen of the image output unit is set. Here, it can be determined that the partition of the screen is set in operation S304 illustrated in FIG. 3. The controller 60 performs operation S410 when the partition of the screen is set and carries out operation S411 when the partition of the screen is not set. The controller 60 displays the second word selected in operation S408 on the image output unit 31 in operation S411. When a single second word is extracted in S406, the controller 60 omits operations S407 and S408 and displays the second word on the image output unit 31 in operation S411.

When the controller 60 determines that the partition of the screen is set in operation S409, the screen partitioning unit 62 partitions the screen based on the number of partitions of the screen, stored in operation S304 illustrated in FIG. 3, in operation S410 and goes to operation S411. The controller 60 respectively displays the first word input in operation 401 and the second word selected in operation S408 on the partitioned parts of the screen.

When the controller 60 determines that the partition of the screen is not set in operation S409, the controller 60 displays only the second word or displays the second word together with the first word on the screen in operation S411.

The controller 60 determines whether the listening key 114 for the second word is input from the input unit 20 in operation S412. When the listening key 14 is input, the voice converter 42 extracts voice data mapped to the second word from the voice DB 52 and provides the voice data to the controller 60 in operation S413.

The controller 60 determines whether the output speed of the extracted voice data is set in operation S414. Here, the controller 60 can determine whether the output speed of the extracted voice data is set according to whether the output speed is stored in operation S307 illustrated in FIG. 3. The controller 60 performs operation S415 when the output speed is set. The speed controller 61 controls the output speed of the voice data to the output speed, which is stored in operation S307 illustrated in FIG. 3, in operation S415. Then, the speed controller 61 outputs the voice data to the voice output unit 32 at the controlled output speed in operation S416.

When the controller 60 determines that the output speed of the voice data is not set in operation S414, the speed controller 61 outputs the voice data whose output speed is not controlled (or whose output speed is set to a default value) to the voice output unit 32.

While it is not illustrated, the speed controller 61 controls the output speed of the voice data and provides the controlled output speed to the voice output unit 32 if the controller 60 receives the signal for controlling the output speed from the input unit 20 before or after the voice data is output even though the output speed is not set.

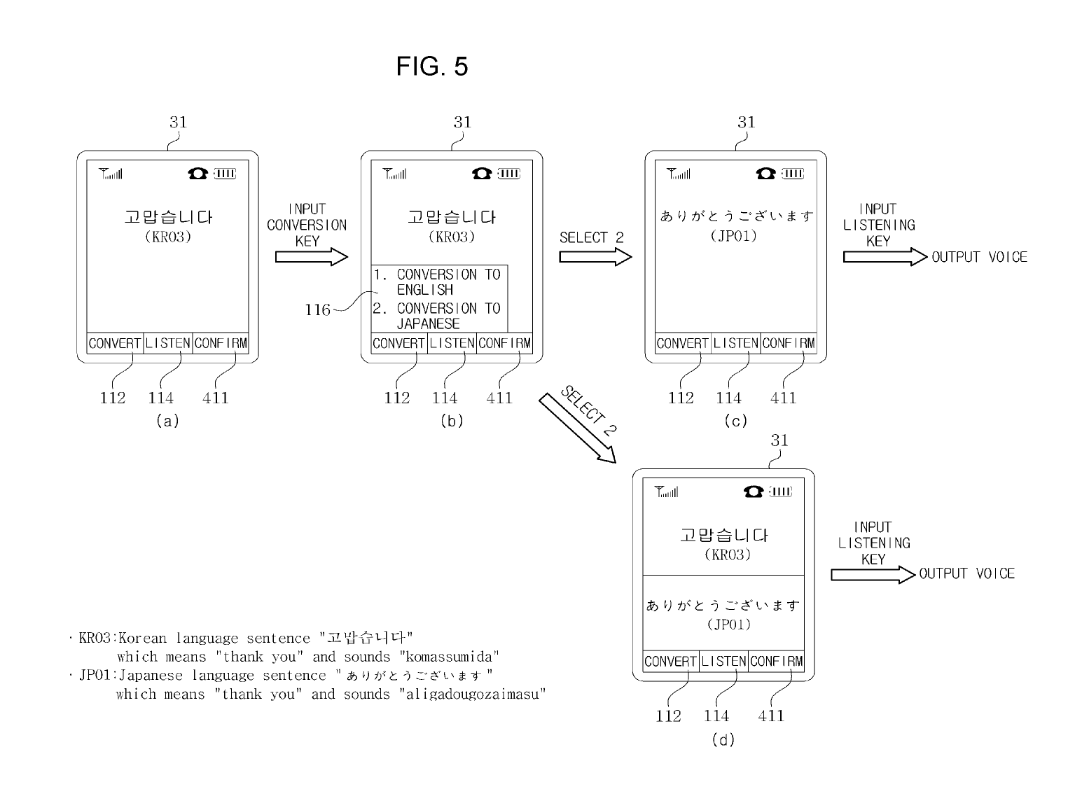

The method of converting a word and outputting a voice corresponding to the converted word according to the first embodiment of the present invention is explained in more detail with reference to first, second, third and fourth images illustrated in FIGS. 5, 6, 7 and 8.

The first image illustrated in FIG. 5 is explained first.

Referring to FIG. 5(a), when a user inputs a first word such as [symbol] using the character/numeral keys, [symbol] is displayed on the image output unit 31. When the user pushes the conversion key 112, a plurality of conversion types 116 corresponding to [symbol] are displayed, as illustrated in FIG. 5(b). The plurality of conversion types 116 include “1. Conversion to English” and “2. Conversion to Japanese”. The conversion types 116 can be displayed in the form of a pop-up window at one side of the screen.

Here, only conversion types corresponding to conversion tables constituted of second words corresponding to the first word can be displayed as the conversion types 116. Otherwise, it is possible to display all the plurality of conversion types and activate only conversion types having second words mapped to the input first word such that the activated conversion types can be selected. For example, when there is no special character mapped to the first word [symbol] , the conversion types 116 do not include “Conversion to special character” in the former case while the conversion types 116 include “Conversion to special character” in the latter case. In this case, “Conversion to special character” is displayed in a non-activated state.

When “2. Conversion to Japanese” is selected using the selection key in order to convert [symbol] to a corresponding Japanese word, a second word [symbol] [symbol] mapped to [symbol] s displayed on the image output unit 31, as illustrated in FIG. 5(c).

When the partition of the screen is set and “2. Conversion to Japanese” is selected, [symbol] and [symbol] [symbol] are respectively displayed on partitioned parts of the screen, as illustrated in FIG. 5(d). Here, the screen of the image output unit 31 can be partitioned in the horizontal direction as illustrated in FIG. 5(d) or in the vertical direction. Although FIG. 5(d) illustrates that the screen is divided into two parts, the screen can be partitioned into more than two parts.

When the user confirms the second word corresponding to [symbol] and then wants to confirm a second word corresponding to [symbol] [symbol] , the user inputs [symbol] [symbol] while [symbol] [symbol] is being displayed and pushes the conversion key 112. Then, [symbol] following [symbol] [symbol] can be displayed.

Here, only [symbol] [symbol] is displayed in FIG. 5(d) because the conversion table stored in the text DB 51 illustrated in FIG. 2 has only [symbol] [symbol] as the second word mapped to [symbol] . The selection key can be input in such a manner that a specific key of the character/numeral keys, which is mapped to the selection key, is pushed or a confirmation key 411 is pushed while the corresponding conversion type is highlighted.

When the user wants to listen to the second word [symbol] [symbol] corresponding to the first word [symbol] as a voice, the user pushes the listening key 114. Then, voice data corresponding to the second word is output through the voice output unit 32.

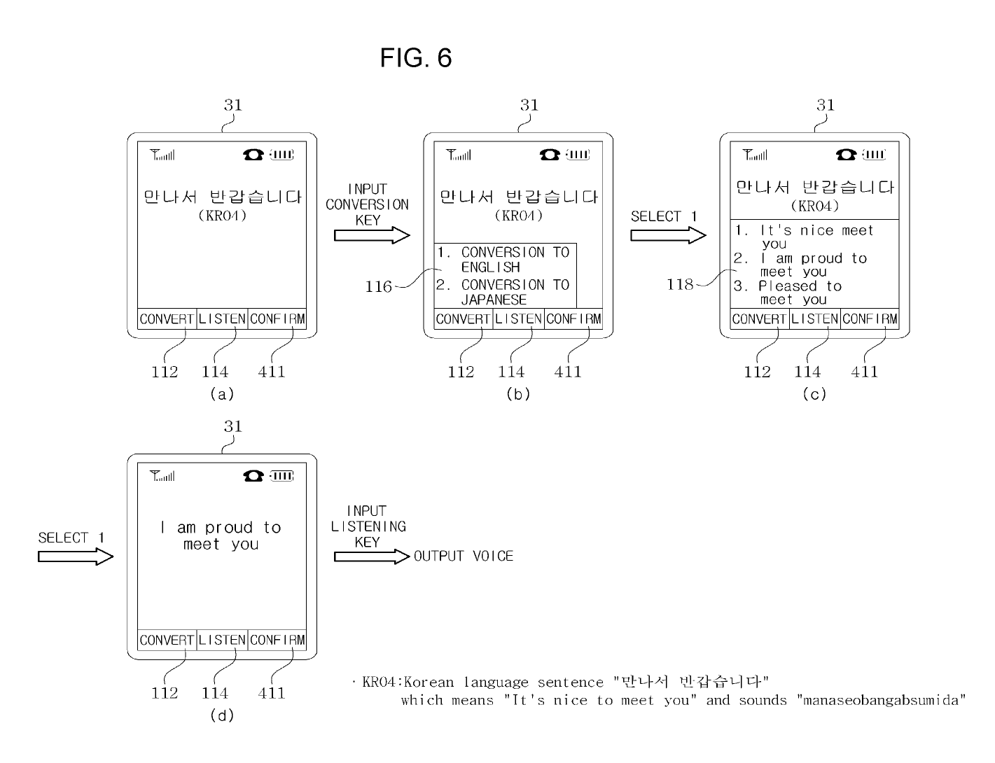

The second image illustrated in FIG. 6 is explained.

Referring to FIG. 6(a), when the user inputs a first word such as [symbol] [symbol] using the character/numeral keys, [symbol] [symbol] is displayed on the image output unit 31. When the user pushes the conversion key 112 in this state, the plurality of conversion types 116 corresponding to [symbol] [symbol] are displayed, as illustrated in FIG. 6(b). FIG. 6(b) illustrates only the conversion types 116 corresponding to conversion tables constituted of second words mapped to the input first word.

When the user selects “1. Conversion to English” using the selection key in order to convert [symbol] [symbol] to a corresponding English word, a plurality of second words 118 mapped to [symbol] [symbol] , that is, ‘It's nice to meet you’, ‘I am proud to meet you’ and ‘Pleased to meet you’ are displayed on the image output unit 31, as illustrated in FIG. 6(c). Here, the plurality of second words 118 are displayed because the conversion table stored in the text DB 51 illustrated in FIG. 2 has multiple second words mapped to [symbol] [symbol] . The plurality of second words 118 are displayed in the region where the conversion types 116 are displayed in FIG. 6(b), as illustrated in FIG. 6(c).

When the user selects ‘2. I am proud to meet you’ using the selection key in FIG. 6(c), the image output unit 31 displays the second word ‘I am proud to meet you’ converted from the first word [symbol] [symbol] , as illustrated in FIG. 6(d). Here, the screen of the image output unit 31 can be partitioned, as described above with reference to FIG. 5(d), such that the first word and the second word can be simultaneously displayed on the screen. The plurality of second words 118 illustrated in FIG. 6(c) are removed from the screen.

When the user wants to listen to the second word ‘I am proud to meet you’ corresponding to the first word [symbol] [symbol] , which is selected from the plurality of second words, as a voice, the user pushes the listening key 114 in FIG. 6(d). Then, voice data corresponding to the converted second word is output through the voice output unit 32.

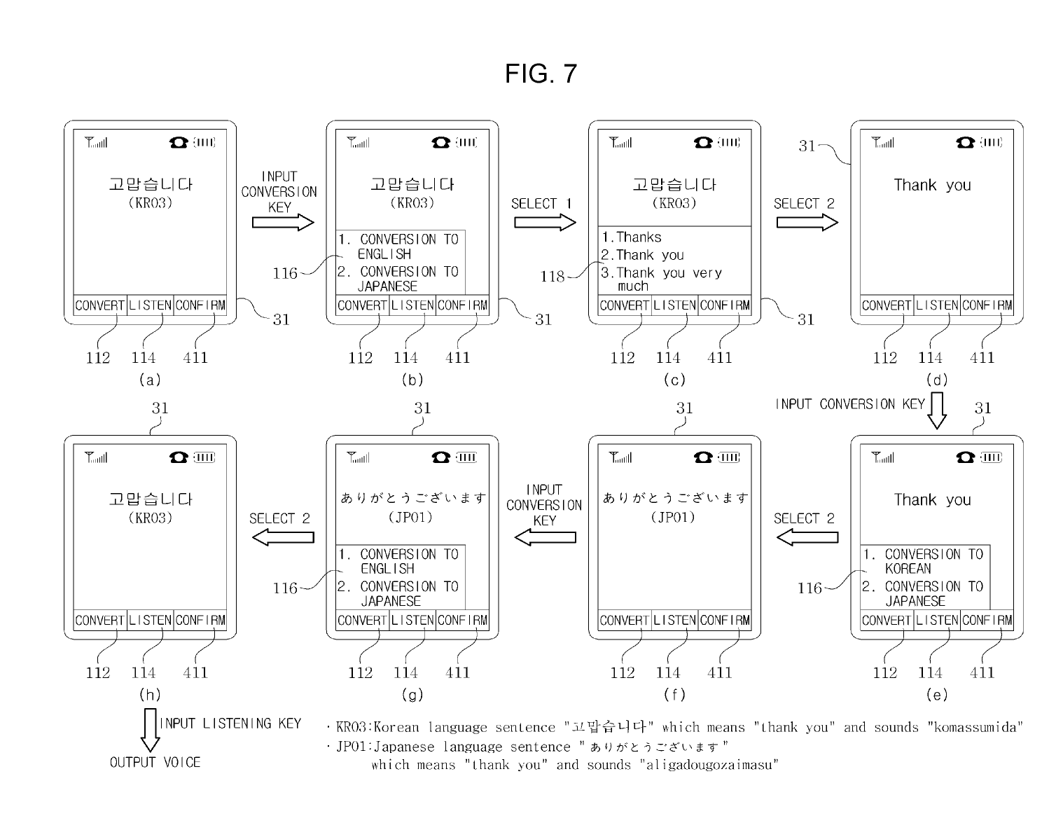

The third image is explained with reference to FIG. 7.

Referring to FIG. 7(a), when the user inputs a first word [symbol] using the character/numeral keys, the image output unit 31 displays [symbol] . When the user pushes the conversion key 112 in this state, a plurality of conversion types 116 corresponding to [symbol] are displayed, as illustrated in FIG. 7(b). FIG. 7(b) illustrates the conversion types 116 corresponding to a conversion table constituted of second words mapped to the input first word.

When the user selects “1. Conversion to English’ using the selection key in order to convert [symbol] to a corresponding English word, a plurality of second words mapped to [symbol] , that is, ‘Thanks’, ‘Thank you’ and ‘Thank you very much’ are displayed on the image output unit 31, as illustrated in FIG. 7(c). When the user selects ‘2. Thank you’ using the selection key, [symbol] is converted to ‘Thank you’ and displayed on the image output unit 31, as illustrated in FIG. 7(d).

When the user wants to convert [symbol] to ‘Thank you’ and then convert ‘Thank you’ to a word in another foreign language, the user pushes the conversion key 112. Then, the conversion types 116 are displayed on the screen of the image output unit 31, as illustrated in FIG. 7(e). In this case, ‘Thank you’ can be converted to a Korean word because an English conversion table includes a first word having ‘Thank you’ as a second word, and thus the conversion types 116 include “1. Conversion to Korean”.

When the user selects “2. Conversion to Japanese”, the word converter 41 does not recognize ‘Thank you’ as a first word and recognizes [symbol] corresponding to ‘Thank you’ as the first word, as illustrated in FIG. 7(f). Furthermore, when a conversion table is generated, as illustrated in FIG. 2(d), and stored in the text DB 51, a third word mapped to the second word ‘Thank you’ is extracted. Accordingly, [symbol] [symbol] mapped to ‘Thank you’ is extracted as the third word from a Japanese conversion table and displayed on the image output unit 31.

When the user wants to convert [symbol] [symbol] to a word in another foreign language, the user pushes the conversion key 112. Then, the conversion types 116 including “1. Conversion to English” and “2. Conversion to Korean” are displayed on the screen, as illustrated in FIG. 7(g). When the user selects “2. Conversion to Korean”, the first word [symbol] corresponding to [symbol] [symbol] is displayed on the image output unit 31.

The user pushes the conversion key 112 when he wants to convert [symbol] to a word in another foreign language. Then, the conversion types 116 including “1. Conversion to English” and “2. Conversion to Korean” are displayed on the screen, as illustrated in FIG. 7(g). When the user selects “2. conversion to Korean”, the first word [symbol] corresponding to [symbol] [symbol] is displayed on the image output unit 31, as illustrated in FIG. 7(h).

The conversion tables corresponding to the plurality of conversion types 1 16 can be previously stored in the text DB 51 in a manufacturing stage or downloaded through the Internet or a network. In addition, the contents of the conversion tables can be added, corrected and deleted by a user. Accordingly, the conversion types can be converted to each other in the conversion tables stored in the text DB 51. For example, if the text DB 51 stores an English conversion table, a Chinese character conversion table, a Japanese conversion table and a Chinese conversion table, an input first word can be converted to a corresponding English word and then converted to corresponding Chinese characters. Furthermore, the converted Chinese characters can be converted to a corresponding Korean word or a corresponding Japanese word. In the example illustrated in FIG. 7, the screen can be partitioned such that the first word and the second word can be simultaneously displayed on the partitioned parts of the screen, as illustrated in FIG. 5. If the screen of the image output unit 31 is partitioned into three parts, the first word, the second word and the third word can be respectively displayed on the partitioned parts of the screen, simultaneously.

Furthermore, when the user pushes the listening key 114 while ‘Thank you’ is being displayed on the image output unit 31, as illustrated in FIG. 7(d), voice data corresponding to ‘Thank you’ is output through the voice output unit 32. If the user wants to hear a voice corresponding to [symbol] [symbol] , the user pushes the listening key 114 in the state illustrated in FIG. 7(f). Then, voice data corresponding to [symbol] [symbol] is output through the voice output unit 32.

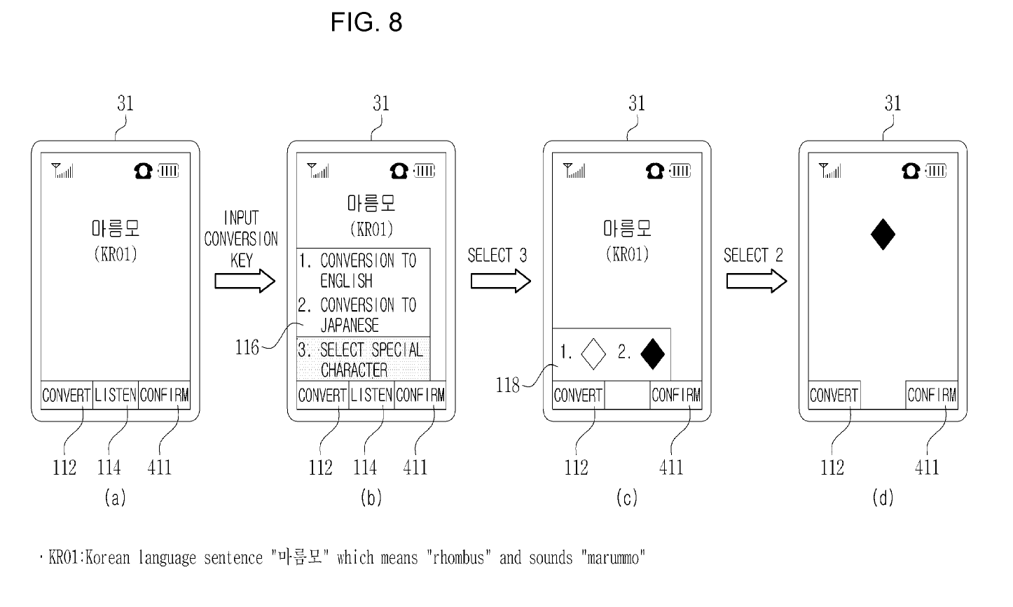

The fourth example is explained with reference to FIG. 8.

Referring to FIG. 8(a), when the user inputs a first word [symbol] (Korean language sentence [symbol] which means “rhombus” and sounds “marummo”)’ using the character/numeral keys, the image output unit 31 displays [symbol] . When the user pushes the conversion key 112 in this state, a plurality of conversion types 116 corresponding to [symbol] are displayed, as illustrated in FIG. 8(b). Here, only “3. Conversion to special character” is activated among the displayed conversion types 116 such that “3. Conversion to special character” can be selected. When a second word corresponding to the first word [symbol] is stored in the only special character conversion table, only “Conversion to special character” can be displayed as a conversion type.

When the user selects “3. Conversion to special character’ using the selection key in order to convert [symbol] to a special character, second words mapped to [symbol] , ‘⋄’ and ‘♦’, are displayed on the image output unit 31, as illustrated in FIG. 8(c). When the user selects ‘2.♦’ using the selection key, [symbol] is converted into ‘♦’ and displayed on the image output unit 31, as illustrated in FIG. 8(d). In the example of FIG. 8, the screen can be partitioned such that the first word and the second word can be simultaneously displayed on the screen.

The selection key can be input in such a manner that a corresponding number of the character/numeral keys of the keypad is pushed or the confirmation key 411 is pushed while a corresponding conversion type is highlighted. Since voice data corresponding to the second word ‘♦’ mapped to the first word [symbol] does not exist, the second word is extracted and displayed and the conversion process is finished.

If an emotion icon corresponding to the first word is displayed, the user can immediately correct the displayed emotion icon through the input unit 20. Here, the controller 60 can store the corrected emotion icon in the text DB 51 when a signal which instructs the corrected emotion icon to be stored is received from the input unit 20 so as to update the emotion icon corresponding to the first word.

### Second Embodiment—Mobile Phone

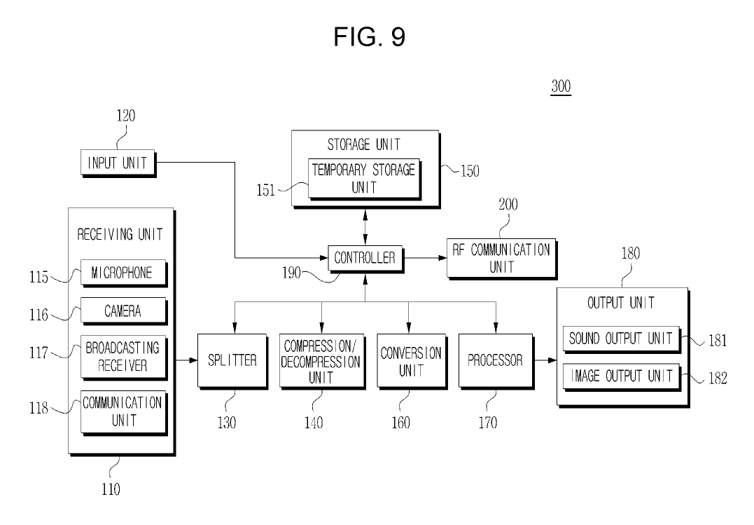

Referring to FIG. 9, a mobile phone 300 according to a second embodiment of the present invention includes a receiving unit 110, an input unit 120, a splitter 130, a compression/decompression unit 140, a storage unit 150, a conversion unit 160, a processor 170, an output unit 180, a controller 190 and an RF communication unit 200.

The mobile phone 300 includes mobile terminals with mobility and a communication function such as personal digital assistants (PAD) and smart phones in addition to general cellular phones.

The receiving unit 110 includes at least one of a microphone 115, a camera 116, a broadcasting receiver 117 and a communication unit 118 and receives an audio signal and a composite video signal required for a user to hear and watch sounds and images. The audio signal is an analog signal or a digital signal and includes a signal received through the microphone 115, a radio broadcasting signal received through the broadcasting receiver 117 and an audio signal downloaded through wireless Internet or a network via the communication unit 118. The composite video signal includes an audio signal and a video signal which are analog signals or digital signals. The composite video signal includes a moving picture captured using the camera 116, a digital broadcasting signal such as a digital multimedia broadcasting (DMB) signal received through the broadcasting receiver 117 and a moving picture and an audio signal downloaded through wireless Internet or a network via the communication unit 118.

The microphone 115 can include a wired/wireless microphone or a headset microphone. The microphone 115 receives an audio signal and amplifies the audio signal. The camera 116 is a module including a lens and an image sensor and captures a moving picture of several to tens frames per second. The broadcasting receiver 117 receives a DMB signal and a radio broadcasting signal. The broadcasting receiver 117 can include a tuner for receiving broadcasting data and a multiplexer for selecting specific broadcasting data from the received broadcasting data. Broadcasting data includes broadcasting information data, an audio signal and a video signal. The communication unit 118 is a wired/wireless communication interface and can be connected to the Internet or a network to receive an audio signal or a composite video signal.

The input unit 120 receives a storing start instruction, a storing completion instruction and various playback instructions including a playback speed and a playback point and includes various function keys and character/numeral keys used to make a telephone call and generate a text message. The input unit 120 can include a keypad, a touch pad and a pointing device.

When the storing start instruction is input through the input unit 120, a currently received audio and video signals are stored in the storage unit 150 from the point at which the storing start instruction is input. Here, a file name can be input to store the audio and video signals. Otherwise, the audio and video signals can be stored with a file name designated by the controller 190. Accordingly, even though receiving of the audio and video signals is interrupted while the audio and video signals are being received and stored, the previously stored audio and video signals cannot be lost and can be preserved.

The splitter 130 splits the composite video signal into a video signal and an audio signal when the storing start instruction is input through the input unit 120. When only an audio signal is received through the receiving unit 1 10, the splitter 130 passes the audio signal without performing a splitting function.

The compression/decompression unit 140 converts the audio signal and the video signal output from the splitter 130 into digital signals and compresses the digital signals or decompress compressed digital signals.

The storage unit 150 stores the digital audio and video signals compressed by the compression/decompression unit 140. The storage unit 150 can use various storage media and can be included in the mobile phone 300 or configured in a form detachably attached to the mobile phone 200 based on an interface.

The storage unit 150 stores the digital audio and video signals compressed by the compression/decompression unit 140 under the control of the controller 190 when the storing start instruction is input though the input unit 120. In the case where digital broadcasting such as DMB or radio broadcasting is received through the broadcasting receiver 117 in real time, when the storing start instruction is input through the input unit 120, the storage unit 150 can store the digital broadcasting from the point at which the storing start instruction is input to the currently received point.

Furthermore, the storing completion instruction can be input when it is required to finish storing of a received voice and image while a user is hearing and viewing the received voice and image.

When broadcasting such as digital broadcasting and radio broadcasting is received in real time, a temporary storage unit 151 included in the storage unit 150 temporarily stores a predetermined portion of a received image, and thus a point slightly prior to the currently received point of the image can be selected using a direction key when the storing start instruction and the storing completion instruction are input.

When a digital sound and a digital image previously stored in the storage unit 150 are played, a playback point and a playback speed can be selected through the input unit 120 to move to a desired playback point and play the digital sound and the digital image or hear and watch the digital sound and the digital image at a desired playback speed.

The compression/decompression unit 140 decompresses digital audio and video signals stored in the storage unit 150 and the conversion unit 160 respectively converts the digital audio and video signals decompressed by the compression/decompression unit 140 into audio and video signals which can be heard and watched by a user.

The processor 170 processes the audio and video signals converted by the conversion unit 160 according to a playback time and a playback speed input through the input unit 120.

The output unit 180 consists of a sound output unit 181 including a speaker and an image output unit 182 including an LCD and plays an audio signal and a video signal.

The controller 190 controls the components of the mobile phone 300. The controller 190 controls a stored composite image to be played from the playback point input through the input unit 120 at the playback speed input through the input unit 120.

The RF communication unit 200 is connected to a base station through a mobile communication network to make a voice call and transmit/receive a text message.

### Sound and Image Processing Method

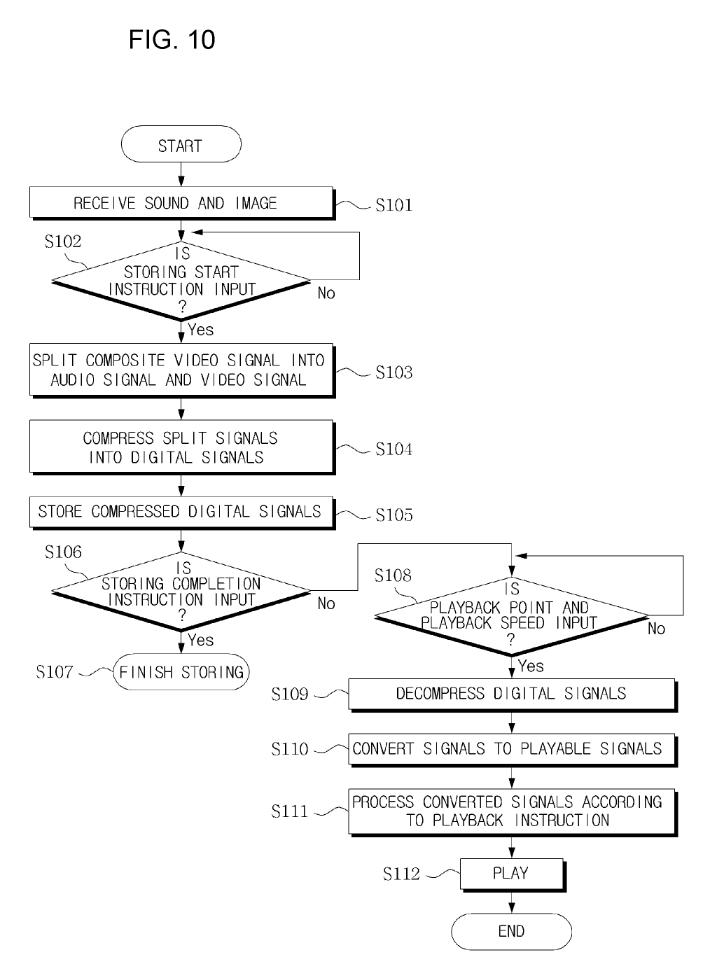

A sound and image processing method of the mobile phone according to the second embodiment of the present invention will be explained with reference to FIGS. 9 and 10.

An audio signal and a composite video signal are received through the receiving unit 110 in operation S101. The controller 190 determines whether the storing start instruction with respect to the received audio signal and composite video signal is input through the input unit 120 in operation S102.

When the storing start instruction is input in operation S102, the splitter 130 splits the received composite video signal into an audio signal and a video signal in operation S103. If only an audio signal is received from the receiving unit 110, operation S103 is omitted.

The compression/decompression unit 140 converts the split audio and video signals into digital signals and compresses the digital signals in operation S104. The controller 190 stores the compressed digital audio and video signals in the storage unit 150 in operation S105.

When it is determined that the storing completion instruction is input through the input unit 120 in operation S106, the storage unit 150 finishes the operation of storing the compressed digital signals in operation S107.

When the storing completion instruction is input in operation S106, the received audio signal and composite video signal are stored in the storage unit 150 through the splitter 130 and the compression/decompression unit 140, and thus the playback point of the stored audio and video signals can be selected using the direction key or the playback speed can be selected using a function key and a character/number key of the mobile phone at any time. Furthermore, various functions can be added to a menu so as to play the stored audio and video signals according to various playback methods.

When the playback point of a stored sound and image is moved using the direction key or a specific key for moving the playback point to the beginning or the end of the stored sound and image is pushed, the playback point is moved to the beginning or the end of the stored sound and image and the stored sound and image are played. When the specific key is pushed to move the playback point to the end, a sound and an image corresponding to currently received audio and composite video signals can be heard and watched.

When the storing completion instruction is not input in operation S106, the controller 190 determines whether the playback point and the playback speed are input through the input unit 120 again in operation S108. That is, when the playback point is selected using the direction key or a menu is selected to select the playback speed in operation S108, the compression/decompression unit 140 decompresses the digital audio and video signals, which are stored in operation S105, in operation S109.

The conversion unit 160 converts the decompressed digital audio and video signals to audio and video signals which can be heard and watched in operation S110. The processor 170 processes the converted audio and video signals according to the playback speed, input in operation S102, in operation S111.

The controller 190 outputs the processed audio and video signal through the output unit 180. Here, the audio signal is output through the sound output unit 181 and the video signal is output through the image output unit 182.

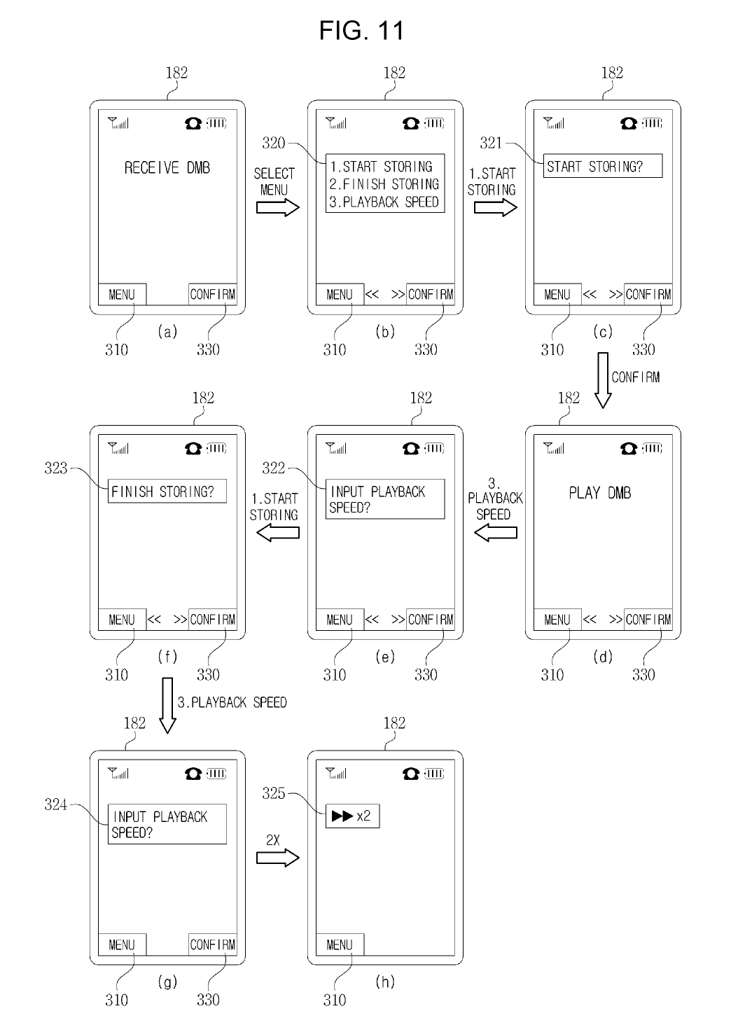

The sound and image processing method of the mobile phone according to the second embodiment of the present invention is explained with reference to exemplary images illustrated in FIG. 11. FIG. 11 illustrates images which represent a process of storing currently received DMB through the mobile phone and, simultaneously, playing the received DMB.

Referring to FIG. 111(a), when a user pushes a menu key of the mobile phone while watching the DMB received through the broadcasting receiver 117 of the mobile phone to select a menu 310, a window 320 representing “1. Begin storing, 2. Finish storing and 3. Playback speed” is displayed, as illustrated in FIG. 111(b). To select “1. Begin storing,” a button ‘1’ among the character/numeral keys of the mobile phone is pushed or a confirmation key 330 is pushed while “1. Begin storing’ is being highlighted.

When “1. Begin storing” is selected in FIG. 11(b), a message 321 for starting storing is displayed, as illustrated in FIG. 11(c). Then, the DMB can be stored from the currently received point. Otherwise, it is possible to move to the temporary storage unit 151, select a point slightly prior to the currently received point of the DMB and store the DMB. In the latter case, it is possible to shift a time period optionally set and then start to store the DMB.

A search symbol << >> illustrated in FIG. 111(c) represents that a point at which storing is begin can be searched using the direction key.

When the storing start instruction is input, a file name is input and the DMB is stored or the DMB is stored with a file name designated by the controller 190 (not shown).

When the confirmation 330 is selected through the confirmation key in FIG. 11(c), the search symbol << >> by which a period from the point at which storing of the DMB is started to the currently received point of the DMB can be searched is displayed on the image output unit 182, as illustrated in FIG. 11(d). When the search symbol << >> is displayed, it is possible to push the direction key of the mobile phone to move a desired playback point in the period from the point at which storing of the DMB is started to the currently received point of the DMB, which is stored in the storage unit 150, and play the DMB.

When the playback point is moved using the direction key or the specific key for moving the playback point to the beginning or to the end is pushed, the playback point is moved to the beginning or the end of the stored DMB and the DMB is played. When the specific key is pushed to move the playback point to the end, a sound and an image corresponding to the currently received audio and composite video signals can be heard and watched.

The menu 310 can include various playback modes having various functions (not shown).

When the user pushes the menu key to select the menu 310 and selects ‘3. Playback speed’ in FIG. 11(d), a message 322 for inputting a playback speed is displayed, as illustrated in FIG. 11(e). When the user inputs a desired playback speed, the stored DMB can be played from the playback point selected using the search symbol << >> at the input desired playback speed.

When the user wants to finish storing in FIG. 11(e), the user pushes the menu key of the mobile phone to select the menu 310 and then selects ‘2. Finish storing’. Then, a message 323 for finishing storing is displayed on the image output unit 182, as illustrated in FIG. 11(f).

Here, storing of the DMB can be finished at the currently received point of the DMB using the confirmation key. Otherwise, it is possible to move to the temporary storage unit 151 using the direction key to finish storing of the DMB at a point slightly prior to the currently received point of the DMB. In the latter case, it is possible to shift an optically set time and finish storing of the DMB. In FIG. 11(f), the search symbol << >> represents that a point at which storing is finished can be searched using the direction key.

In the case where real-time audio and composite video signals such as DMB, radio broadcasting and sounds and images heard and watched through the Internet are received, data of predetermined portions of the currently played sound and image is stored in the temporary storage unit 151 of the storage unit 150 for input of the storing start instruction and the storing completion instruction. When the storing start instruction or the storing completion instruction is not input, the data stored in the temporary storage unit 151 is deleted. Furthermore, if the storing start instruction or the storing completion instruction is input when the temporary storage unit 151 temporarily stores an image, it is possible to shift an optically set time and start or finish storing.

When the menu 310 is selected after a file is stored and ‘3. Playback speed’ is selected in FIG. 11(f), a message 324 for inputting a playback speed is displayed, as illustrated in FIG. 11(g), and thus a playback speed with respect to the stored file can be set.

When the playback speed is input in FIG. 11(g), the stored file is played at the desired playback speed, as illustrated in FIG. 11(h), through operations S108 through S112 of FIG. 10. When 2× is input, for example, a message 325 which represents that data is played at 2× can be displayed on the image output unit 182.

Accordingly, if the storing start instruction is input through the input unit 120 when DMB is received in real time, it is possible to freely move to a desired playback point between the point at which the storing start instruction is input and the currently received point of the DMB and play the DMB or control the playback speed. In addition, it is possible to input the storing completion instruction after the DMB is watched to store the entire period of the DMB.

Although FIG. 11 illustrates a process of storing DMB received in real time and, simultaneously, playing the DMB, the present invention is not limited thereto. For example, the present invention can be applied to radio broadcasting, sounds and images heard and watched through the Internet and moving pictures captured by cameras, which are received in real time.

Furthermore, it is possible to set a playback period of an image previously stored in the mobile phone and play the image according to a desired playback instruction. In this case, an operation of displaying stored composite images and selecting a composite image to be played from the displayed composite images can be added. The stored composite images can be displayed in the form of a list or a thumbnail.

The image previously stored in the mobile phone includes a file storing DMB received through the broadcasting receiver 117 in real time and a composite image transmitted through the communication unit 118 and stored.

When an image stored in the mobile phone 300 is played through the image output unit 182, a desired playback point can be selected using the direction key or a playback speed can be input to play the image at a desired playback speed even though the image is being played. Here, the present invention can be applied to a file storing a predetermined playback period of DMB received in real time, a file storing audio and composite video signals transmitted through the communication unit 118, an audio signal received through a microphone or an audio signal such as a real-time radio broadcasting signal, a file storing an audio signal or a video signal transmitted through the Internet and an image captured using a camera and stored.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A method of processing a sound and an image in a mobile phone, comprising the steps of:
receiving a composite video signal including an audio signal and a video signal and storing the received composite video signal;
inputting a playback point of the stored composite video signal and a playback speed exceeding I X; and
playing a sound and an image corresponding to the stored composite video signal from the input playback point at the input playback speed.

2. The method of processing a sound and an image in a mobile phone according to claim 1, wherein the composite video signal includes a moving image captured by a camera of the mobile phone, a received digital broadcast and a downloaded moving image.

3. The method of processing a sound and an image in a mobile phone according to claim 2, wherein the step of storing the received composite video signal comprises the steps of:
receiving the composite video signal;
splitting the received composite video signal into the audio signal and the video signal according to input of a storing start instruction;
converting the audio signal and the video signal into digital signals, compressing the digital signals and storing the compressed digital signals; and
finishing storing of the received composite video signal according to input of a storing completion instruction.

4. The method of processing a sound and an image in a mobile phone according to claim 3, wherein the step of inputting the playback point and the playback speed comprises the step of selecting a composite image to be played from stored composite images.

5. The method of processing a sound and an image in a mobile phone according to claim 4, wherein the step of playing the sound and the image comprises the steps of:
decompressing compressed audio and video signals of the selected composite image to convert the audio and video signals to audio and video signals which can be heard and watched;
processing the converted audio and video signals according to the input playback speed; and
outputting the processed audio and video signals from the input playback point.

6. The method of processing a sound and an image in a mobile phone according to claim 3, wherein, when the composite video signal is received in real time, the received composite video signal is compressed and stored and, simultaneously, the received composite video signal is processed at the input playback speed to output the composite video signal from the input playback point.

7. A mobile phone comprising:
a receiving unit for receiving a composite video signal including an audio signal and a video signal;
a storage unit for storing the received composite video signal;
an input unit through which a playback point of the stored composite video signal and a playback speed exceeding 1× are input; and
a controller for playing a sound and an image corresponding to the stored composite video signal from the input playback point at the input playback speed.

8. The mobile phone according to claim 7, wherein the receiving unit includes at least one of a microphone, a camera, a broadcasting receiver and a communication unit.

9. The mobile phone according to claim 8, further comprising:
a splitter for splitting the received composite video signal into the audio signal and the video signal when a storing start instruction is input through the input unit; and
a compression/decompression unit for converting the split audio and video signals into digital signals, compressing the digital signals, storing the compressed digital signals in the storage unit and finishing storing of the received composite video signal when a storing completion instruction is input through the input unit.

10. The mobile phone according to claim 9, wherein the input unit receives a signal for selecting a composite image to be played from stored composite images.

11. The mobile phone according to claim 10, further comprising:
a conversion unit for decompressing compressed audio and video signals of the selected composite image to convert the audio and video signals to audio and video signals that can be heard and watched;
a processor for processing the converted audio and video signals according to the input playback speed; and
an output unit for outputting the processed audio and video signals from the input playback point.

12. The mobile phone according to claim 9, wherein, when the receiving unit receives the composite video signal in real time, the compression/decompression unit compresses the received composite video signal and stores the compressed composite video signal and, simultaneously, the processor processes the composite video signal at the input playback speed to output the composite video signal from the input playback point.

13. A method of converting a word and outputting a voice corresponding to the converted word in a mobile phone, comprising the steps of:
inputting a first word;
displaying at least one conversion type corresponding to the first word on a screen;
converting the first word to a second word of a conversion type selected from the displayed conversion type;
displaying the converted second word on the screen; and
outputting voice data corresponding to the second word when a voice output request for the displayed second word is input.

14. The method of converting a word and outputting a voice corresponding to the converted word in a mobile phone according to claim 13, wherein the step of converting the first word to the second word comprises the steps of:
selecting a specific conversion type from the displayed conversion type;
extracting a conversion table corresponding to the selected conversion type from a text DB;
searching the extracted conversion table to extract the second word mapped to the first word and converting the first word to the second word;
displaying a plurality of second words when the plurality of second words are extracted; and
converting the first word to a second word selected from the plurality of second words.

15. The method of converting a word and outputting a voice corresponding to the converted word in a mobile phone according to claim 14, further comprising the step of determining whether the screen is partitioned and setting the output speed of the voice data before the step of displaying the converted second word on the screen, and the step of displaying the converted second word on the screen displays only the converted second word or displays the converted second word together with the input first word when it is determined that the screen is not partitioned, partitions the screen and respectively displays the first word and the second word on the partitioned parts of the screen.

16. The method of converting a word and outputting a voice corresponding to the converted word in a mobile phone according to claim 15, wherein the step of outputting the voice data corresponding to the second word comprises the steps of:
receiving the voice output request for the displayed second word;
extracting the voice data corresponding to the second word from a voice DB and converting the second word to the voice data; and
outputting the voice data.

17. A mobile phone comprising:
an input unit through which a first word is input;
a word converter for providing at least one conversion type corresponding to the input first word and converting the first word to a second word of a conversion type selected from the provided conversion type;
an image output unit for displaying the input first word, the provided conversion type and the converted second word on a screen; and
a voice converter for converting the second word to voice data corresponding thereto and outputting the voice data when a voice output request for the second word is input through the input unit.

18. The mobile phone according to claim 17, further comprising:
a text DB storing a plurality of conversion tables corresponding to the at least one conversion type; and
a voice DB storing the voice data mapped to the second word,
wherein the word converter extracts a conversion table corresponding to the selected conversion type from the text DB when the specific conversion type is selected from the provided conversion type through the input unit, searches the extracted conversion table to extract the second word mapped to the first word and converts the first word to the second word, and the voice converter extracts the voice data corresponding to the second word from the voice DB and converts the second word to the voice data when the voice output request for the second word is input through the input unit.

19. The mobile phone according to claim 18, wherein the word converter displays the plurality of second words on the screen when the plurality of second words are extracted and, when one of the plurality of second words is selected, converts the first word to the selected second word.

20. The mobile phone according to claim 19, further comprising:
a speed controller for storing the output speed of the voice data, input through the input unit, in the storage unit and outputting the voice data corresponding to the second word at the output speed input through the input unit or stored in the storage unit; and
a screen partitioning unit for storing the number of partitions of the screen, input through the input unit, in the storage unit and partitioning the screen into as many parts as the stored number to respectively display the first word and the second word on the partitioned parts of the screen.
